(19) United States
(12) Patent Application Publication
(10) Pub. No.: US 2007/0182345 A1
(43) Pub. Date: Aug. 9, 2007

(54) Monitor and power circuit thereof

(75) Inventors: Po-Wen Wang, Shindian City (TW); Chia-Tse Yeh, Jhongli City (TW); Chien-Kun Huang, Taipei City (TW)

Correspondence Address: RABIN & Berdo, PC, 1101 14TH STREET, NW, SUITE 500, WASHINGTON, DC, 20005, US

(73) Assignee: BenQ Corporation, Taoyuan Shien (TW)

(21) Appl. No.: 11/647,117

(22) Filed: Dec. 29, 2006

(30) Foreign Application Priority Data
Jan. 24, 2006 (TW) 95102704

(51) Int. Cl. H05B 41/36

(52) U.S. Cl. 315/307

(57) ABSTRACT

A monitor and a power circuit thereof. The monitor includes a power circuit and a lamp. The power circuit driving the lamp to emit light includes an AC-to-DC converter, a transformer, a switch, a pulse width modulation (PWM) unit, a DC filter and a Royer circuit. The AC-to-DC converter receives a first AC voltage and generates a first DC voltage. The transformer has a secondary side coil for generating a second AC voltage, and a primary side coil, which has one end for receiving the first DC voltage and the other end coupled to a low potential through the switch. The PWM unit controls the switch to turn on to adjust the second AC voltage. The DC filter filters the second AC voltage into a second DC voltage. The Royer circuit generates a third AC voltage for driving the lamp to emit the light according to the second DC voltage.

This application claims the benefit of Taiwan application Serial No. 95102704, filed Jan. 24, 2006, the subject matter of which is incorporated herein by reference.

### BACKGROUND OF THE INVENTION

1. Field of the Invention

The invention relates in general to a monitor and a power circuit thereof, and more particularly to a monitor with less power stage transformation and a power circuit thereof.

2. Description of the Related Art

FIG. 1 (Prior Art) is a block diagram showing a conventional monitor 100. Referring to FIG. 1, the monitor 100 includes a power supply 110 and a lamp inverter 120. The power supply 110 includes an AC-to-DC converter 111, a transformer 112, a DC filter 113, a PWM (Pulse Width Modulation) unit 114, a switch 115 and a feedback circuit 116. The lamp inverter 120 includes a DC-to-DC converter 121, a Royer circuit 122, a lamp 123, a PWM unit 124 and a feedback circuit 125.

The AC-to-DC converter 111 receives an AC voltage Va1, converts the AC voltage Va1 into a DC voltage and then outputs the DC voltage to a primary side of the transformer 112. The PWM unit 114 controls the switch 115 to control the primary side coil of the transformer 112, according to a feedback signal Fb2, so as to adjust the secondary side coil of the transformer 112 to generate an AC voltage. The DC filter 113 receives the AC voltage generated by the secondary side coil of the transformer 112 and thus generates a DC voltage Vd1. The DC filter 113 provides a feedback signal Fb1 to the feedback circuit 116, which generates the feedback signal Fb2 and outputs the feedback signal Fb2 to the PWM unit 114.

The DC-to-DC converter 121 decreases the DC voltage Vd1 to obtain a DC voltage Vd2, such as 10.8 volts or 10.7 volts. The Royer circuit 122 converts the DC voltage Vd2 into an AC voltage Va2, which is then inputted to the lamp 123 so that the desired luminance is obtained. When the lamp 123 is emitting the light, the lamp 123 also generates a feedback signal Fb3. The feedback circuit 125 receives the feedback signal Fb3 and a luminance adjusting signal B1, and thus generates a feedback signal Fb4. The PWM unit 124 adjusts and stabilizes the DC voltage Vd2 of the DC-to-DC converter 121 to adjust the luminance of the lamp 123 according to the feedback signal Fb4.

However, the trend of the light and thin monitor products makes the processing of the electronic elements in the aspect of temperature become more severe. The current monitor architecture has three stages of transformer circuits, and each stage of transformer circuit has the power loss of 10%. It also represents that 30% of power becomes the thermal loss of the electronic elements during the transforming processes. Thus, the power is lost and the thermal loss also shortens the lifetimes of the electronic elements, so the lifetime of the monitor is shortened.

### SUMMARY OF THE INVENTION

The invention is directed to a monitor and a power circuit thereof. The conventional three-stage transformer circuit is modified into a two-stage transformer circuit. So, the power loss of one stage of transformation can be reduced, and the lifetimes of the electronic elements and the monitor can be lengthened.

According to the present invention, a power circuit is provided. The power circuit drives a lamp to emit light and includes an AC-to-DC converter, a transformer, a switch, a PWM unit, a DC filter and a Royer circuit. The AC-to-DC converter receives a first AC voltage and thus generates a first DC voltage. The transformer has a primary side coil and a secondary side coil for generating a second AC voltage. The primary side coil has one end for receiving the first DC voltage and the other end coupled to a low potential through the switch. The PWM unit controls the switch to turn on to adjust the second AC voltage such that the luminance of the lamp is adjusted by indirectly adjusting the second AC voltage. The DC filter filters the second AC voltage into a second DC voltage. The Royer circuit generates a third AC voltage for driving the lamp to emit the light according to the second DC voltage.

The invention will become apparent from the following detailed description of the preferred but non-limiting embodiment. The following description is made with reference to the accompanying drawings.

### BRIEF DESCRIPTION OF THE DRAWINGS

FIG. 1 (Prior Art) is a block diagram showing a conventional monitor.

FIG. 2 is block diagram showing a monitor according to a preferred embodiment of the invention.

FIG. 3 is a circuit diagram showing the monitor according to the preferred embodiment of the invention.

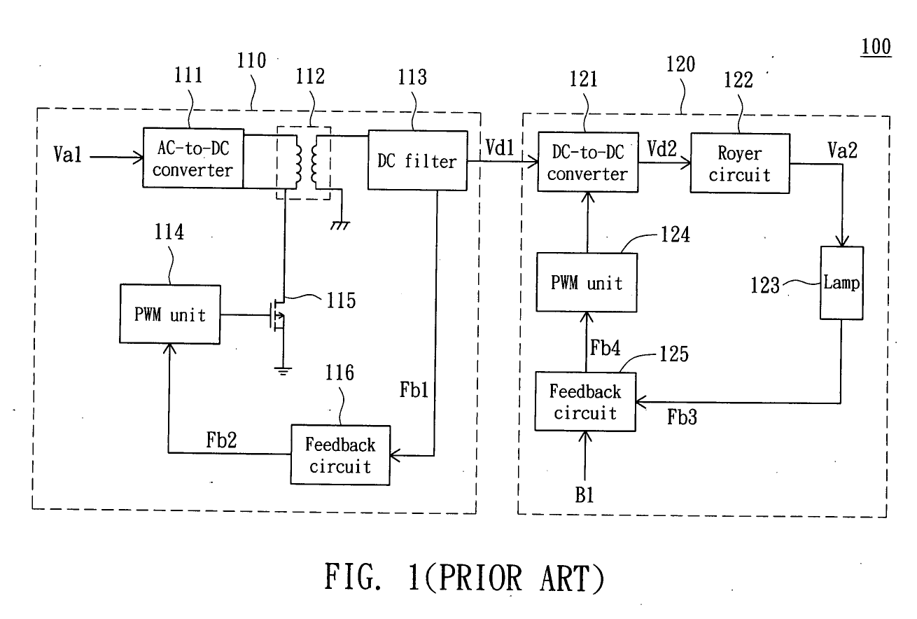

### DETAILED DESCRIPTION OF THE INVENTION

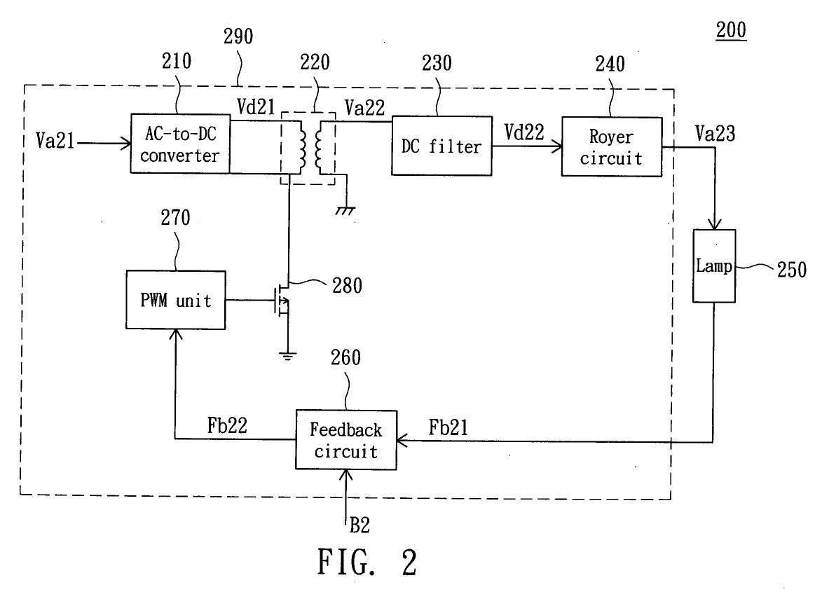

FIG. 2 is block diagram showing a monitor 200 according to a preferred embodiment of the invention. Referring to FIG. 2, the monitor 200 includes a power circuit 290 and a lamp 250. The power circuit 290 includes an AC-to-DC converter 210, a transformer 220, a DC filter 230, a Royer circuit 240, a feedback circuit 260, a PWM unit 270 and a switch 280.

The AC-to-DC converter 210 receives an AC voltage Va21 and thus generates a DC voltage Vd21. The transformer 220 has a primary side coil and a secondary side coil. The primary side coil of the transformer 220 has one end for receiving the DC voltage Vd21 generated by the AC-to-DC converter 210, and the other side coupled to a low potential through the switch 280. The PWM unit 270 controls the switch 280 to turn on and off, according to a feedback signal Fb22, so as to adjust an AC voltage Va22 of the secondary side coil of the transformer 220.

The DC filter 230 filters the AC voltage Va22 into a DC voltage Vd22. After the Royer circuit 240 has received the DC voltage Vd22, an AC voltage Va23 is generated according to the principle of inductor-capacitor resonance.

The lamp 250 emits light according to the AC voltage Va23 and transmits a feedback signal Fb21 to the feedback circuit 260. The feedback circuit 260 receives the feedback signal Fb21 and a luminance adjusting signal B2 and thus generates the feedback signal Fb22.

The main object of providing the PWM unit 270 and the feedback circuit 260 is to obtain the current light emitting state of the lamp 250 according to the feedback signal Fb21 so that the luminance of the lamp 250 is stabilized by indirectly controlling the AC voltage Va23 received by the lamp 250. The AC voltage Va23 may range from 600 volts to 800 volts.

The luminance adjusting signal B2 is generated as follows. The user operates adjusting keys of the monitor to generate adjusting signals for adjusting the luminance, and the monitor processes the adjusting signals corresponding to the adjusting keys into the luminance adjusting signal B2 to adjust the luminance of the lamp 250. After the PWM unit 270 and the feedback circuit 260 have processed the luminance adjusting signal B2, the luminance of the lamp 250 may be adjusted by indirectly controlling the AC voltage Va23 received by the lamp 250.

A sum of the feedback signal Fb21 and the luminance adjusting signal B2 is a constant. When the level of the luminance adjusting signal B2 increases, the level of the feedback signal Fb21 decreases, which also represents that the AC voltage Va23 decreases such that the luminance of the lamp 250 is decreased. When the level of the luminance adjusting signal B2 decreases, the level of the feedback signal Fb21 increases, which represents that the AC voltage Va23 increases such that the luminance of the lamp 250 is increased.

The switch 280 may be, for example, an NMOS transistor, which has a gate for receiving a control signal of the PWM unit 270, a source coupled to the ground, and a drain coupled to the primary side coil of the transformer 220.

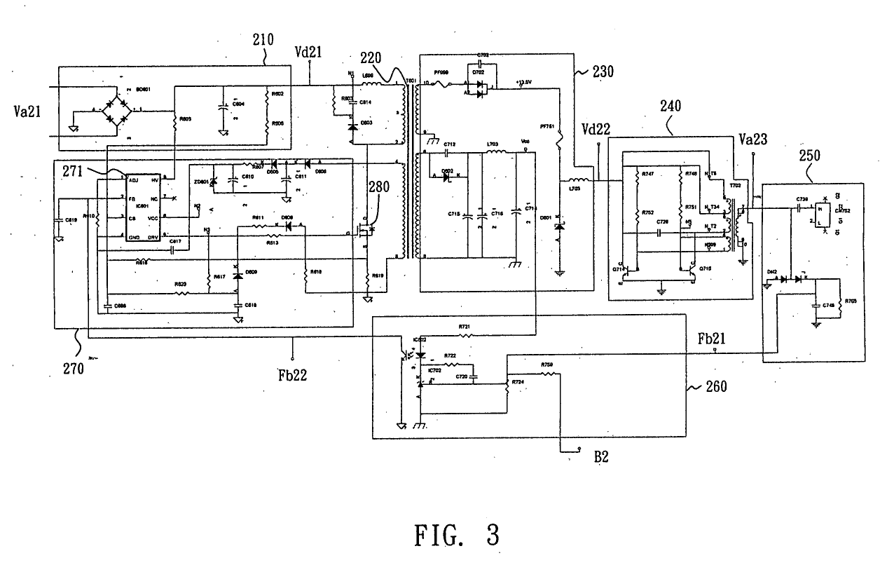

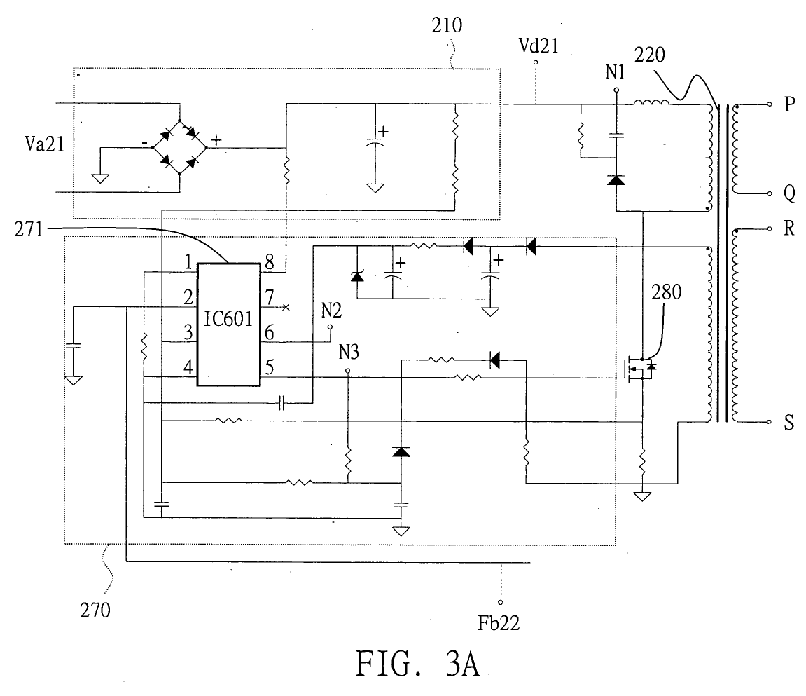

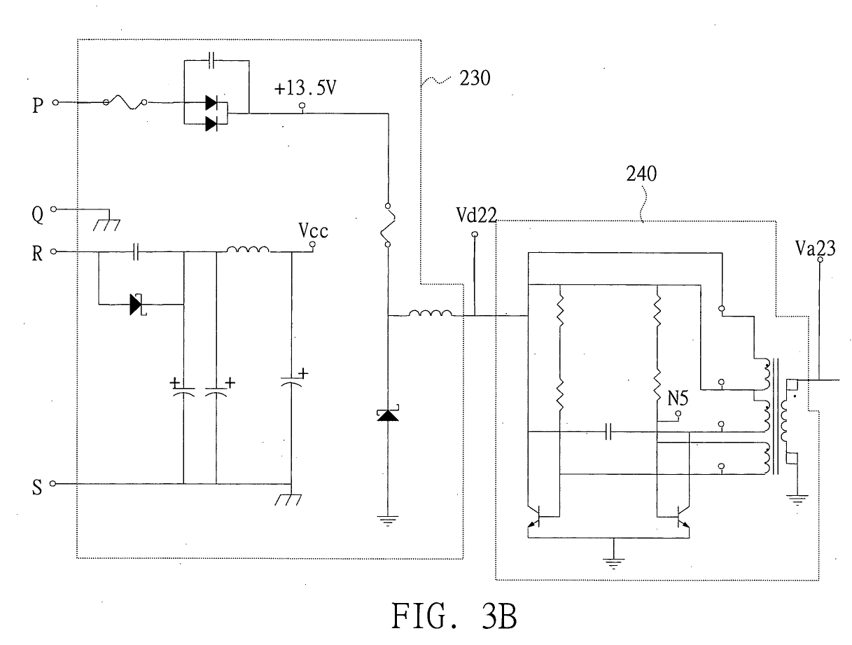

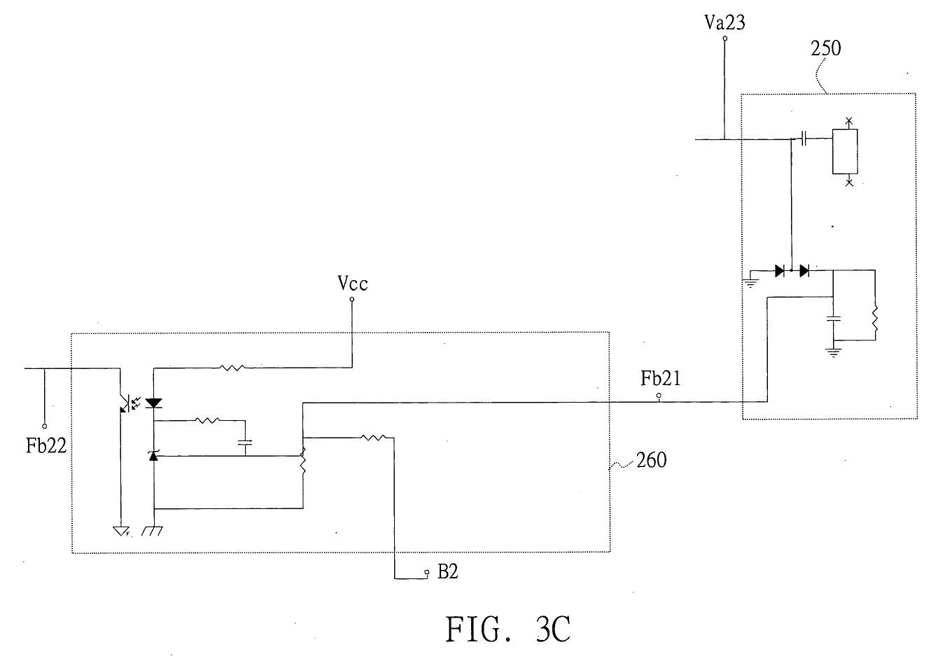

FIG. 3 is a circuit diagram showing the monitor according to the preferred embodiment of the invention. Referring to FIG. 3, the AC-to-DC converter 210 has a full-wave bridge rectifier circuit for rectifying the AC voltage into the DC voltage according to the unidirectional turn-on property of the diode. Thereafter, the capacitor filters the waves to provide a stabler DC voltage Vd21 to the transformer 220.

The DC filter 230 filters the AC voltage Va22 into the DC voltage Vd22 according to the following principle. Because the AC voltage generated by the secondary side coil of the transformer 220 has the square waves, the DC voltage can be obtained according to the unidirectional turn-on property of the diode of the DC filter 230. The lamp 250 includes a lamp CN752 and a filter circuit. The lamp CN752 receives the AC voltage Va23 to emit the light. The filter circuit generates the DC voltage, which is the feedback signal Fb21, using the diode.

In the feedback circuit 260, the feedback signal Fb21 and the luminance adjusting signal B2 are coupled to the same terminal, so the sum of the signals Fb21 and B2 is a constant. The feedback circuit 260 includes an opto-coupler. A light emitting diode converts the electric signal into an optical signal, and the photo detector of the opto-coupler receives the optical signal to generate the electric signal. The electric isolation effect of the opto-coupler is to isolate the primary side of the transformer 220 from the secondary side of the transformer 220 to avoid any interference therebetween.

The PWM unit 270 includes a control chip 271 for controlling the overall operations of the PWM unit 270. The control chip 271 receives the feedback signal Fb22 to control the switch 280 to turn on so that the primary side of the transformer 220 generates the AC voltage. The control chip 271 can convert a high DC voltage into a low DC voltage, so the independent step-down adjusting function of the PWM unit 270 can be utilized in practice in order to achieve the requirement of decreasing the voltage in the conventional lamp inverter 120.

In the monitor and the power circuit thereof according to the embodiment of the invention, the voltage step-down converting circuit, the PWM unit and the feedback circuit are controlled by the control chip of the pulse width regulator of the power supply. Thus, the conventional three-stage transformer circuit is modified into the two-stage transformer circuit, and the power loss of one-stage transformation can be saved. Consequently, the lifetimes of the electronic elements and thus the monitor can be lengthened. Because one stage of transformation is eliminated, the element cost of the one-stage transformer circuit can be saved.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A monitor, comprising:
an AC-to-DC converter for receiving a first AC voltage and thus generating a first DC voltage;
a transformer having a primary side coil and a secondary side coil for generating a second AC voltage;
a switch, wherein one end of the primary side coil receives the first DC voltage, and the other end of the primary side coil is coupled to a low potential through the switch;
a PWM (Pulse Width Modulation) unit for controlling the switch to turn on to adjust the second AC voltage;
a DC filter for filtering the second AC voltage into a second DC voltage;
a Royer circuit for generating a third AC voltage according to the second DC voltage;
a lamp, wherein the third AC voltage drives the lamp to emit light; and
a feedback circuit for receiving a first feedback signal provided when the lamp is emitting the light and thus generating a second feedback signal, wherein the PWM unit controls the switch according to the second feedback signal.

2. The monitor according to claim 1, wherein the feedback circuit further receives a luminance adjusting signal, and a sum of the first feedback signal and the luminance adjusting signal is a constant.

3. A power circuit for driving a lamp, the power circuit comprising:
an AC-to-DC converter for receiving a first AC voltage and thus generating a first DC voltage;
a transformer having a primary side coil and a secondary side coil for generating a second AC voltage;
a switch, wherein one end of the primary side coil receives the first DC voltage, and the other end of the primary side coil is coupled to a low potential through the switch;
a PWM (Pulse Width Modulation) unit for controlling the switch to turn on to adjust the second AC voltage in order to adjust luminance of the lamp by indirectly adjusting the second AC voltage;
a DC filter for filtering the second AC voltage into a second DC voltage;
a Royer circuit for generating a third AC voltage to drive the lamp to emit light according to the second DC voltage; and
a feedback circuit for receiving a first feedback signal provided when the lamp is emitting the light to generate a second feedback signal, wherein the PWM unit controls the switch according to the second feedback signal.

4. The power circuit according to claim 3, wherein the feedback circuit further receives a luminance adjusting signal, and a sum of the first feedback signal and the luminance adjusting signal is a constant.
